(19) United States
(12) Patent Application Publication
(10) Pub. No.: US 2016/0042754 A1
(43) Pub. Date: Feb. 11, 2016

(54) METAL MEMBER FOR MAGNETIC STORAGE MEDIUM AND MAGNETIC STORAGE MEDIUM

(71) Applicants: Furukawa Electric Co., Ltd., Tokyo (JP); C. Uyemura & Co., Ltd., Osaka-shi (JP)

(72) Inventors: Wataru Kumagai, Tokyo (JP); Hideki Takahashi, Tokyo (JP); Masanobu Onishi, Tokyo (JP); Yasuo Fujii, Tokyo (JP); Hiroki Ota, Tokyo (JP); Hideyuki Hatakeyama, Tokyo (JP); Hideyuki Takami, Hirakata-shi (JP)

(73) Assignees: Furukawa Electric Co., Ltd., Tokyo (JP); C. Uyemura & Co., Ltd., Osaka-shi (JP)

(21) Appl. No.: 14/792,091

(22) Filed: Jul. 6, 2015

(30) Foreign Application Priority Data
Jul. 7, 2014 (JP) 2014-139904

(51) Int. Cl. G11B 5/65

(52) U.S. Cl. CPC G11B 5/653

(57) ABSTRACT

A metal member for magnetic storage medium includes an aluminum alloy substrate, and a nonmagnetic layer formed on at least one surface of the aluminum alloy substrate, and the nonmagnetic layer comprises a Ni—Cu—P based alloy containing 5 mass % to 50 mass % Cu and 100 ppm to 1000 ppm Pb.

### TECHNICAL FIELD

The present disclosure relates to a metal member for magnetic storage medium and a magnetic storage medium. Particularly, the present disclosure relates to a metal member for magnetic storage medium including a nonmagnetic Ni—Cu—P plating layer formed in a manufacturing process of a magnetic disk and a magnetic storage medium having such a metal member for magnetic storage medium.

### BACKGROUND

There have been efforts to increase a recording density of magnetic disks (magnetic storage media) used for storage devices such as hard disk drives (HDD), and for an even higher recording density in the future, it is essential to refine magnetic particles. However, in general, refinement of magnetic particles causes a decrease in a force retaining an orientation of the recorded magnetization, and thus a phenomenon called heat fluctuation occurs which is demagnetization at a low thermal energy at about room temperature. Due to an influence of heat fluctuation, a limit to a recording density using an existing vertical magnetic recording method is expected to be 1 Tbits/inch².

As a technique for suppressing the aforementioned heat fluctuation phenomenon and for further increasing the recording density, a thermally assisted magnetic recording method is becoming of interest. A thermally assisted magnetic recording method is a method including instantaneously heating micro-regions on a magnetic disc using a laser or the like, the micro-regions being regions on which data is to be recorded, and recording data on the heated micro-regions using a magnetic head. With this method, even with a magnetic material having a high retaining force that cannot be recorded with an existing magnetic head, the retaining force can be instantaneously decreased by heating, and thus it is possible to solve the problem of heat fluctuation. Accordingly, since such a technique makes it possible to achieve refinement of magnetic particles and stable recording at the same time, there is an expectation for a super high recording density.

A Fe—Pt based material is a magnetic material that is considered as being suitable for heat assist magnetic recording. When forming a film of a Fe—Pt based material by sputtering, it is necessary to perform heating at a higher temperature than conventional, and for example, heating/film forming time of about ten seconds is required at a substrate temperature of 400° C. to 600° C. (e.g., see Japanese Laid-Open Patent Publication No. 2012-99179).

However, when forming a Ni—P plating layer on a conventional aluminum alloy substrate (e.g., JIS (Japanese Industrial Standard) 5086 alloy), there is no problem in sputtering of a magnetic material at 300° C. or below, which is commonly performed, but sputtering of a Fe—Pt based magnetic material at a substrate temperature of 400° C. to 600° C. causes problems such as warping of the substrate and a decrease in the flatness. Further, there is a problem such as roughening of a plated surface due to coarsening of crystal grains in an aluminum substrate, and there is a further problem that it is not usable as a magnetic storage medium due to spontaneous magnetization as a result of crystallization of a Ni—P plated layer subjected to a high temperature.

Japanese Laid-Open Patent Publication No. 2012-99179 mentioned above discloses requirements for an aluminum alloy substrate without a plating layer, and specifies compositions and conditions of manufacture for suppressing a decrease in flatness or coarsening of crystal grains, but does not disclose a structure including a plating layer or failures due to magnetization of the plating. Japanese Laid-Open Patent Publication No. 2012-99179 discloses discussions on application of a Ni—Cu—P plating, a Ni—Mo—P plating, or Ni—W—P plating having a higher heat-resistance than that of the commonly used Ni—P plating, but there is no disclosure about specific reasons for selecting the plating.

For stabilization of a nonmagnetic layer, it is necessary to form a stable plating layer, and thus bath stability at the time of forming a plating layer is required. Therefore, when selecting a plating, bath stability should also be taken into consideration.

It is an object of the present disclosure to provide a metal member for magnetic storage medium including a substrate and a plating layer formed thereon, that can achieve a higher recording density of a magnetic material by reducing heat influence while forming a film, and that can stabilize a nonmagnetic layer by forming a stable plating layer, and a magnetic storage medium having such a metal member for magnetic storage medium.

### SUMMARY OF THE INVENTION

The present inventors carried out assiduous studies on an aluminum alloy substrate for magnetic storage medium having a plating layer, and as a result, reached the findings that, even in a case where a magnetic material is formed into a film at 400° C. to 600° C., magnetization of the plating layer can be suppressed by forming a nonmagnetic layer of a Ni—Cu—P based alloy and the nonmagnetic layer contains 5 mass % to 50 mass % Cu and 100 ppm to 1000 ppm Pb.

The aforementioned object of the present invention is achieved with the invention described below.

(1) A metal member for magnetic storage medium includes an aluminum alloy substrate, and a nonmagnetic layer formed on at least one surface of the aluminum alloy substrate, the nonmagnetic layer comprising a Ni—Cu—P based alloy containing 5 mass % to 50 mass % Cu and 100 ppm to 1000 ppm Pb.

(2) The metal member for magnetic storage medium according to the above (1), wherein the nonmagnetic layer comprises a Ni—Cu—P based alloy containing 5 mass % to 20 mass % Cu.

(3) The metal member for magnetic storage medium according to the above (1) or (2), wherein the nonmagnetic layer is formed by plating.

(4) The metal member for magnetic storage medium according to any one of the above (1) to (3), wherein a magnetic flux density after being heated for ten seconds at 550° C. is less than 1 gauss.

(5) A magnetic storage medium includes a magnetic layer provided on the nonmagnetic layer of the metal member for magnetic storage medium according to any one of the above (1) to (4).

(6) The magnetic storage medium according to the above (5), wherein a Fe—Pt based magnetic layer is formed on the nonmagnetic layer of the metal member.

(7) The magnetic storage medium according to the above (5) or (6), wherein, after the metal member is brought to a temperature of 400° C. to 600° C., the magnetic layer is formed on the nonmagnetic layer by sputtering.

### EFFECT OF THE INVENTION

According to the present disclosure, even in a case where sputtering is performed after heating a substrate to 400° C. to 600° C. when forming a magnetic layer on a metal member for magnetic storage medium, magnetization of the plating layer due to heating during the sputtering can be largely suppressed, and it is possible to achieve a higher recording density for a magnetic disk. Also, according to the present disclosure, since the nonmagnetic layer contains Pb by a very small amount, i.e., 100 ppm to 1000 ppm, decomposition of the plating bath is less likely to occur and a bath stability improves in electroless plating. Therefore, a plating layer can be formed stably and a stable nonmagnetic layer can be formed.

### DESCRIPTION OF EMBODIMENTS

A metal member for magnetic storage medium according to an embodiment of the present disclosure includes an aluminum alloy substrate, and a nonmagnetic layer formed on at least one surface of the aluminum alloy substrate, the nonmagnetic layer being formed of a Ni—Cu—P based alloy containing 5 mass % to 50 mass % Cu and 100 ppm to 1000 ppm Pb. A metal member for magnetic storage medium according to another embodiment of the present disclosure has a magnetic flux density of less than 1 gauss (1.0×10⁻⁴ T (tesla)) after being heated at 400° C. to 600° C. for 2 to 10 seconds.

(Aluminum Alloy Substrate)

An aluminum alloy substrate for magnetic disk is a doughnut-shaped thin sheet having a hole at a center. Since a substrate for magnetic disk is required to be non-magnetic, lightweighted and highly stiff, and further required to have a smooth surface, the substrate for magnetic disk is made of an aluminum alloy having a low density and that can be easily mirror finished. An Al—Mg based alloy is used as this aluminum alloy, since it has a sufficient strength required for a shock resistance property of magnetic disks for HDDs and provides a sufficient surface smoothness. Specifically, it is an alloy that complies with JIS H 4000, for example, an A5086 alloy (consisting of 3.50 mass % to 4.50 mass % Mg; less than or equal to 0.50 mass % Fe; less than or equal to 0.40 mass % Si; 0.20 mass % to 0.70 mass % Mn; 0.05 mass % to 0.25 mass % Cr; less than or equal to 0.10 mass % Cu; less than or equal to 0.15 mass % Ti; less than or equal to 0.25 mass % Zn; residual Al; and incidental impurities) or an A5083 alloy (consisting of 4.00 mass % to 4.90 mass % Mg; less than or equal to 0.40 mass % Fe; less than or equal to 0.40 mass % Si; 0.40 mass % to 1.00 mass % Mn; 0.05 mass % to 0.25 mass % Cr; less than or equal to 0.10 mass % Cu; less than or equal to 0.15 mass % Ti; less than or equal to 0.25 mass % Zn; residual Al; and incidental impurities).

Alternatively, another aluminum alloy substrate may be, in terms of reducing surface defects, made of high purity aluminum of 99.94 mass % to 99.99 mass % from which Si and Fe are reduced as much as possible, or, in terms of ensuring plating properties, made of a Cu- or Zn-added aluminum alloy.

An aluminum alloy clad substrate may also be used as an aluminum alloy substrate. A clad substrate includes a plurality of aluminum alloy sheets that are laminated and adhered to each other. The aluminum alloy sheets may be of different compositions.

(Non-Magnetic Layer)

A non-magnetic layer is a layer formed on either or both main surfaces of the aluminum alloy substrate. In general, it is a plated layer formed by plating an aluminum alloy substrate. The nonmagnetic layer has a thickness of, for example, 1.0 μm to 12 μm. Similarly to the aluminum alloy substrate, the nonmagnetic layer needs to be non-magnetic, and it is also necessary to maintain a non-magnetic property under a high temperature environment. Accordingly, the nonmagnetic layer is made of a Ni—Cu—P based alloy, and the Cu content in the Ni—Cu—P based alloy is 5 mass % to 50 mass %, and preferably 5 mass % to 20 mass %. When the Cu content is less than 5 mass %, a non-magnetic property during the heating is not maintained, and when the Cu content is greater than 50 mass %, a precipitation rate largely decreases. When the Cu content is greater than or equal to 60 mass %, precipitation (reaction) almost stops.

The Ni—Cu—P based alloy constituting the nonmagnetic layer according to an embodiment of the present disclosure contains 100 ppm to 1000 ppm Pb. When the Pb content is less than 100 ppm, a desired nonmagnetic layer cannot be obtained since the bath stability in the plating process is decreased. When the Pb content is greater than 1000 ppm, reactivity worsens and a precipitation rate decreases, and a non-plated portion may be produced at an outer periphery. That is to say, the reliability of the nonmagnetic layer is decreased. Although the nonmagnetic layer of the present disclosure containing Pb may be referred to as a layer made of a Ni—Cu—P—Pb based alloy, it is denoted as a Ni—Cu—P based alloy indicating main components of the alloy in the present disclosure, since the Pb content is less than contents of other components.

Other than the above-mentioned Cu and Pb, the Ni—Cu—P based alloy forming the nonmagnetic layer of an embodiment of the present disclosure preferably comprises Ni, P and incidental impurities. In a case where the nonmagnetic layer is formed of plating, the incidental impurities refer to elements or chemical compounds which could be incidentally included in the nonmagnetic layer.

(Manufacturing Method of a Metal Member for Magnetic Storage Medium and Magnetic Storage Medium)

At first, an aluminum alloy prepared by predetermined components is cast to form an aluminum alloy ingot, and the ingot is subjected to face-machining to form a plate.

Thereafter, it is subjected to a homogenizing process, a hot rolling process and a cold rolling process to form a rolled aluminum alloy sheet. It is to be noted that an intermediate annealing process may be performed during or before the cold rolling process. The aforementioned homogenizing process is not essential and may be omitted.

Then, the rolled aluminum alloy sheet is punched into a torus shape to form a blank. Then, a stacked heat processing, which is a process in which a plurality of blanks are stacked and annealed, is performed to compensate for distortion to provide an aluminum alloy substrate.

Then, the aluminum alloy substrate is subjected to machining and grinding, and further subjected to degreasing and etching.

Then, a zincate treatment (Zn substitution process) is applied on a surface of the aluminum alloy substrate to form a Zn substitution layer, and thereafter, an electroless Ni—Cu—P based plating process is applied on a surface of a zincated substrate using a Ni—Cu—P based plating bath containing a predetermined amount of Cu and Pb to form a nonmagnetic layer on the substrate surface. Thereafter, a polishing process is applied to smooth the surface of the nonmagnetic layer, if needed, to thereby fabricate a metal member for magnetic storage medium.

Then, a sputtering process is applied to a metal member for magnetic storage medium to form a magnetic layer of, for example, a Fe—Pt based magnetic material, on a surface the nonmagnetic layer of the metal member for magnetic storage medium. To provide a high recording density, this sputtering process was performed, for example, for 2 to 10 seconds on the metal member for magnetic storage medium at 400° C. to 600° C., and preferably for ten seconds at 550° C. In this manner, after bringing the metal member for magnetic storage medium to the above-mentioned temperature, a magnetic layer was formed on a surface of the nonmagnetic layer by sputtering to provide a magnetic disk (magnetic storage medium).

(Magnetic Flux Density of Metal Member for Magnetic Storage Medium Being Less than 1 Gauss)

The metal member for magnetic storage medium that is manufactured as described above has a magnetic flux density of less than 1 gauss. The magnetic flux density is measured using, for example, a vibrating sample magnetometer that detects a change over time of the magnetic flux formed by a magnetic substance. According to the present disclosure, even if a plated layer is exposed to a high temperature environment in a magnetic layer forming process during the manufacture of a magnetic disk, the metal member for magnetic storage medium has a magnetic flux density of less than 1 gauss. Thus, magnetization of the plated layer is suppressed, and a higher high recording density can be achieved for magnetic storage mediums including thermally assisted magnetic recording.

A metal member for magnetic storage medium and magnetic storage medium according to the aforementioned embodiment are described above, but the present disclosure is not limited to the embodiment described above, and various modifications and alterations can be made within the scope of the present disclosure.

### EXAMPLES

The present disclosure will be described in detail based on the following examples. The present disclosure is not limited to the examples described below.

### Example 1

1) Blank processing, 2) grinding, and 3) plating were performed to obtain a metal member for magnetic storage media. To be more specific, 1) an aluminum alloy rolled sheet corresponding to JIS 5086 was punched by a pressing process to prepare a toric blank. Thereafter, a plurality of toric blanks were stacked and an annealing process was performed while applying a pressure using a jig or the like. 2) Then, inner and outer circumferences and main surfaces of the blank were machined to prepare an aluminum alloy substrate having an outside diameter of 95 mm φ. 3) The prepared aluminum alloy substrate was subjected to degreasing, etching, and double zincate treatment as a plating pretreatment, and thereafter, a plating process was performed. It was immersed in an electroless plating solution for 90 minutes, the electroless plating solution containing 0.05 mol/L nickel sulfate, 0.02 mol/L copper sulfate, 0.3 mol/L sodium hypophosphite, 0.2 mol/L sodium citrate, 0.05 mol/L borax, 0.1 ppm stabilizer, at a bath temperature of 80° C., and a Cu concentration in the plating solution being adjusted to 0.2 g/L, to prepare a metal member for magnetic storage medium. The metal member for magnetic storage medium prepared in this manner had a nonmagnetic layer including 77.5 mass % Ni, 10.0 mass % Cu, and 12.5 mass % P, and Pb content was 100 ppm. Note that “ppm” in the present invention indicates mass ppm.

The Pb content in the nonmagnetic layer of the metal member was measured by an atomic absorption method. As the atomic absorption method, a test solution obtained by dissolving the plating film in nitric acid was sprayed in an acetylene-air flame and atomic absorption by lead was measured at a wavelength of 283.3 nm, and the quantity of lead was determined. The following a) to d) were used as reagents.

a) water: water classified as A3 under JIS K 0557 or an equivalent

b) nitric acid: used for measurement of a toxic metal or an equivalent

c) lead standard solution (1 mg Pb/mL): a standard solution of lead (1000 mg Pb/L) tracable to a specific standard substance (national measurement standard) under Measurement Act Article 134.

d) lead standard solution (0.1 mg Pb/mL): A total amount of the lead standard solution (1 mg Pb/mL) 10 mL described above at c) is placed in a flask 100 mL, (1+1)2 mL nitric acid is added and water is added up to a marked line. Alternatively, a standard solution of lead (100 mg Pb/L) tracable to a specific standard substance (national measurement standard) under Measurement Act Article 134.

As an instrument or an apparatus, a flame atomic absorption spectrometry apparatus specified under JIS K 0121 was used that has a hollow cathode lamp or an electrodeless discharge lamp for an element to be measured, and that is capable of performing background correction. A calibration curve was created at the time of measurement of the test solution.

Thereafter, the metal member for magnetic storage medium was subjected to a heating test at 550° C. for ten seconds such that the heating condition is similar to the condition in a process of forming a film of a magnetic substance. The heat treatment was carried out using an infrared lamp heating apparatus (RTP-6) manufactured by ULVAC-RIKO, Inc. under a condition in which the temperature is increased at a temperature increase rate of 100° C./min and the heating is maintained at 550° C.

### Example 2

Except that Pb content of the plating layer was changed from 100 ppm to 600 ppm, an aluminum alloy sheet was obtained in a manner similar to Example 1.

### Example 3

Except that Pb content of the plating layer was changed from 100 ppm to 1000 ppm, an aluminum alloy sheet was obtained in a manner similar to Example 1.

### Example 4

Except that Cu content of the plating layer was changed from 10 mass % to 30 mass %, an aluminum alloy sheet was obtained in a manner similar to Example 2.

### Example 5

Except that Cu content of the plating layer was changed from 10 mass % to 40 mass %, an aluminum alloy sheet was obtained in a manner similar to Example 2.

### Comparative Example 1

Except that Cu content of the plating layer was changed from 10 mass % to zero, an aluminum alloy sheet was obtained in a manner similar to Example 2.

### Comparative Example 2

Except that Cu content of the plating layer was changed from 10 mass % to zero, and, except that 0.5 mass % Mo was added, an aluminum alloy sheet was obtained in a manner similar to Example 2.

### Comparative Example 3

Except that Cu content of the plating layer was changed from 10 mass % to 3 mass %, an aluminum alloy sheet was obtained in a manner similar to Example 2.

### Comparative Example 4

Except that Cu content of the plating layer was changed from 10 mass % to 60 mass %, an aluminum alloy sheet was obtained in a manner similar to Example 2.

### Comparative Example 5

Except that Pb content of the plating layer was changed from 600 ppm to 50 ppm, an aluminum alloy sheet was obtained in a manner similar to Example 3.

### Comparative Example 6

Except that Pb content of the plating layer was changed from 600 ppm to 1200 ppm, an aluminum alloy sheet was obtained in a manner similar to Example 3.

### Comparative Example 7

Except that Cu content of the plating layer was changed from 10 mass % to 49 mass %, Pb content was changed from 100 ppm to 0 ppm, and the heating temperature was changed from 55° C. to 40° C., an aluminum alloy sheet was obtained in a manner similar to Example 1.

Then, Examples 1 to 5 and Comparative Examples 1 to 7 prepared as above was evaluated by the following method.

### [Bath Stability]

A 1-L glass beaker with its surface partially scratched with #200 sandpaper was prepared and a bath stability was evaluated by presence or absence of precipitation on a beaker after 10 hours has elapsed after increasing the temperature of the 1-L plating solution. Here, a symbol “x” denotes “bad” which is a case where precipitation appeared on the beaker after an elapse of 5 hours, a symbol “◯” denotes “good” which is case where a precipitation appeared on the beaker after an elapse of 10 hours, and a symbol “⊚” denotes “excellent” which is a case where precipitation did not appear on the beaker after an elapse of 10 hours.

### [Precipitation Rate]

A precipitation rate was evaluated by a film thickness achieved during the forming of a plating film. Here, a symbol “x” denotes “bad” which is a case where a plating film thickness was less than 5 μm and a plate-less portion occurs at an outer periphery by a decrease in the precipitation rate, a symbol “◯” denotes “good” which is a case where the plating film thickness is 5 μm to 8 μm, and “◯” denotes “excellent” which is a case where the plating film thickness is 8 μm to 12 μm.

### [Environmental Influence]

Taking a Pb regulation value (less than 1000 ppm) in a Ni—Cu—P based alloy specified by RoHS regulation and ELV directive as a reference, a symbol “⊚” denotes “excellent” which is a case of 0 ppm to 200 ppm, a symbol “◯” denotes “good” which is a case of 200 ppm to 1000 ppm, and “a symbol “x” denotes “bad” which is a case excessive of 1000 ppm.

[Magnetic Property after Heating]

Using a vibration sample type magnetometer (product manufactured by Riken Denshi Co., Ltd., device name “BHV-50”), magnetic force lines were formed from a change in magnetic force and a magnetic field strength (gauss) was measured.

Results of measurements and evaluations by the aforementioned method are shown in Table 1.

TABLE 1

| | NON-MAGNETIC LAYER | | | | | | | MAGNETIC | |
|---|---|---|---|---|---|---|---|---|---|
| | (PLATING LAYER) | | | HEATING | | | | PROPERTY | |
| | Cu | Pb | Mo | TEMPERA- | | PRECIPI- | ENVIRON- | AFTER | OVERALL |
| | CONTENT | CONTENT | CONTENT | TURE | BATH | TATION | MENTAL | HEATING | EVALUA- |
| | (MASS %) | (ppm) | (MASS %) | (° C.) | STABILITY | RATE | INFLUENCE | G (GAUSS) | TION |
| EXAMPLE 1 | 10 | 100 | 0 | 550 | ◯ | ◯ | ⊚ | <1 | ◯ |
| EXAMPLE 2 | 10 | 600 | 0 | 550 | ⊚ | ⊚ | ◯ | <1 | ⊚ |
| EXAMPLE 3 | 10 | 1000 | 0 | 550 | ⊚ | ◯ | ◯ | <1 | ◯ |
| EXAMPLE 4 | 30 | 600 | 0 | 550 | ⊚ | ⊚ | ◯ | <1 | ⊚ |
| EXAMPLE 5 | 40 | 600 | 0 | 550 | ⊚ | ◯ | ◯ | <1 | ◯ |
| COMPARATIVE | [symbol] | 600 | 0 | 550 | ⊚ | ⊚ | ◯ | [symbol] | X |
| EXAMPLE 1 | | | | | | | | | |
| COMPARATIVE | [symbol] | 600 | 0.5 | 550 | ⊚ | ⊚ | ◯ | [symbol] | X |
| EXAMPLE 2 | | | | | | | | | |
| COMPARATIVE | [symbol] | 600 | 0 | 550 | ⊚ | ⊚ | ◯ | [symbol] | X |
| EXAMPLE 3 | | | | | | | | | |
| COMPARATIVE | [symbol] | 600 | 0 | 550 | ⊚ | [symbol] | ◯ | <1 | X |
| EXAMPLE 4 | | | | | | | | | |
| COMPARATIVE | 40 | [symbol] | 0 | 550 | [symbol] | ◯ | ⊚ | <1 | X |
| EXAMPLE 5 | | | | | | | | | |
| COMPARATIVE | 40 | [symbol] | 0 | 550 | ⊚ | [symbol] | [symbol] | <1 | X |
| EXAMPLE 6 | | | | | | | | | |
| COMPARATIVE | 49 | [symbol] | 0 | 400 | [symbol] | ◯ | ⊚ | <1 | X |
| EXAMPLE 7 | | | | | | | | | |

N.B. NUMERICAL VALUES IN BOLD ITALIC IN THE TABLE ARE OUT OF APPROPRIATE RANGE OF EXAMPLES

From the results shown in Table 1, it can be seen that each of Examples 1 to 5 did not produce magnetization by crystallization in the nonmagnetic layer even after heating at after 550° C. for ten seconds, and thus had a good thermal stability.

It was found that Comparative Example 1 is not suitable for thermally assisted magnetic recording since the plating layer does not contain Cu, and magnetization by the crystallization of the nonmagnetic layer occurred due to the aforementioned high temperature heating. It was also found that in Comparative Example 2, the plating layer does not contain Cu but contains 0.5 mass % Mo, and similarly to Comparative Example 1, magnetization by the crystallization of the nonmagnetic layer occurred due to the aforementioned high temperature heating. It was found that Comparative Example 3 is not suitable for thermally assisted magnetic recording since Cu content was insufficient, and the some magnetization generation of the nonmagnetic layer was observed. In Comparative Example 4, an excessive amount of Cu was added and thus the precipitation rate decreased by a large amount, in Comparative Example 5, since Pb content was insufficient, bath stability decreased. In Comparative Example 6, due to an increase in Pb content, an environmental influence worsened and the precipitation rate also worsened. It was found that none of Comparative Examples 4 to 6 were suitable for thermally assisted magnetic recording. Further, as for Comparative Example 7, Pb was not contained, and bath stability decreased.

Since the metal member for magnetic storage medium of the present disclosure has an improved heat resistance, it is preferably used as an aluminum alloy sheet for magnetic disks of a high recording density that is installed in a storage unit such as a HDD.

1: A metal member for magnetic storage medium, comprising:
an aluminum alloy substrate; and
a nonmagnetic layer provided on at least one surface of the aluminum alloy substrate,
wherein the nonmagnetic layer comprises a Ni—Cu—P based alloy containing 5 mass % to 50 mass % Cu and 100 ppm to 1000 ppm Pb.

2: The metal member of claim 1,
wherein the nonmagnetic layer comprises a Ni—Cu—P based alloy containing 5 mass to 20 mass % Cu.

3: The metal member of claim 1,
wherein the nonmagnetic layer is a plated layer.

4: The metal member of claim 1,
wherein a magnetic flux density after being heated for ten seconds at 550° C. is less than 1 gauss.

5: A magnetic storage medium, comprising:
a metal member; and
a magnetic layer provided on the nonmagnetic layer of the metal member,
wherein the metal member comprises:
an aluminum alloy substrate; and
a nonmagnetic layer provided on at least one surface of the aluminum alloy substrate, and
wherein the nonmagnetic layer comprises a Ni—Cu—P based alloy containing 5 mass % to 50 mass % Cu and 100 ppm to 1000 ppm Pb.

6: The magnetic storage medium of claim 5,
wherein a Fe—Pt based magnetic layer is provided on the nonmagnetic layer of the metal member.

7: The magnetic storage medium of claim 5,
wherein, after the metal member is brought to a temperature of 400° C. to 600° C., the magnetic layer is formed on the nonmagnetic layer by sputtering.
